(19) United States
(12) Patent Application Publication
(10) Pub. No.: US 2002/0117787 A1
(43) Pub. Date: Aug. 29, 2002

(54) Leaf bumper assembly

(75) Inventors: Michel Beaudoin, Drummondville (CA); Pierre-Louis Foucault, St-Lambert (CA); Erik Nadeau, Levis (CA)

Correspondence Address: MERCHANT & GOULD PC, P.O. BOX 2903, MINNEAPOLIS, MN, 55402-0903, US

(73) Assignee: CANIMEX INC., Drummondville, QC (CA)

(21) Appl. No.: 10/079,971

(22) Filed: Feb. 19, 2002

Related U.S. Application Data
(60) Provisional application No. 60/269,389, filed on Feb. 20, 2001.

(51) Int. Cl. F16F 1/18

(52) U.S. Cl. 267/41

(57) ABSTRACT

A leaf bumper assembly for stopping displacement of a garage door guided along a side rail track. The leaf bumper assembly includes a bracket and a strap. The bracket has a first portion rigidly connected to a fixed structure and a second portion positioned to abut with an edge of the garage door for stopping displacement thereof. The strap has a first end affixed to the first portion of the bracket and a second end affixed to the second portion of the bracket. By virtue of its design, the leaf bumper assembly prevents broken pieces from falling to the ground when the bracket of the assembly is broken.

### FIELD OF THE INVENTION

The present invention relates to a leaf bumper assembly. More particularly, the present invention relates to a leaf bumper assembly for stopping displacement of a cable-operated door, such as a garage door, guided and travelling along a side rail track.

### BACKGROUND OF THE INVENTION

It is known in the art that cable-operated doors, such as commercial and residential sectional garage doors for example, whether standard, high lift, or even vertical, usually require devices which are used to stop the door at the end of its travel when it reaches the fully opened raised position.

It is also known in the art that leaf bumper springs are often used as garage door stoppers. These bumpers generally consist of a metallic J-shaped bracket having a first portion rigidly connected to the side rail track along which the garage door travels and a second portion positioned to abut with an edge of the garage door for stopping displacement thereof when it reaches the fully opened raised position. The first portion of the bracket is usually connected to the rail track by appropriate attaching devices, such as brackets, bolts, nuts, and the like.

A major problem associated with the above-mentioned type of garage door bumper is that, since its main function is to repeatedly absorb substantial impacts from the garage door over a fairly long period of time, weak points will be generated along the bumper bracket due to fatigue stress which may result in the breaking of the bracket. This breaking of the bracket not only renders it inoperable for acting as a garage door bumper, which is very undesirable for obvious reasons, but is also dangerous in that the broken pieces may cause important damages to property or serious personal injuries when falling to the ground.

In order to overcome the above-mentioned problems, different manufacturing processes have been developed in order to impart to the bracket of the leaf spring bumper with greater resiliency and improved resistance to fatigue stress by various heat treatments thereof, but such attempts in order to prolong the life of the bumpers have not been able to prevent the bumpers from eventually breaking and having broken pieces fall to the ground.

Hence, in light of the aforementioned, there is a need for an improved leaf bumper assembly which, by virtue of its design, would be safer than the leaf bumper springs known in the art. Furthermore, there is a need for an improved leaf bumper assembly which would be more cost-effective than some of the leaf bumper springs known in the prior art. Moreover, there is a need for an improved leaf bumper assembly which would be easy to manufacture and easy to use.

### SUMMARY OF THE INVENTION

An object of the present invention is to provide a leaf bumper assembly which would overcome some of the above-mentioned needs, and would thus be an improvement over the leaf bumper springs known in the prior art.

In accordance with the invention, the above object is achieved by a leaf bumper assembly for stopping displacement of a cable-operated door guided along a side rail track, said leaf bumper assembly comprising:

a bracket having first and second portions, the first portion of the bracket being rigidly connected to a fixed structure and the second portion of the bracket being positioned to abut with an edge of the cable-operated door for stopping displacement thereof; and

a strap having first and second ends, the first end of the strap being affixed to the first portion of the bracket and the second end of the strap being affixed to the second portion of the bracket.

Preferably, the fixed structure is a portion of the side rail track.

Preferably also, the first portion of the bracket is connected to the portion of the side rail track by means of an L-shaped bracket.

Preferably also, the bracket and the strap have complementary J-shaped configurations.

Preferably also, the cable-operated door is a garage door.

The invention and its advantages will be better understood upon reading the following non-restrictive description of a preferred embodiment thereof, made with reference to the accompanying drawings.

### BRIEF DESCRIPTION OF THE DRAWINGS

FIG. 1 is a perspective view of a leaf bumper assembly according to a preferred embodiment of the invention, the leaf bumper assembly being shown mounted onto a side rail track and cooperating with an edge of a garage door.

FIG. 2 is another perspective view of what is shown in FIG. 1.

FIG. 3 is another perspective view of what is shown in FIG. 1.

FIG. 4 is a perspective view of the strap of the leaf bumper assembly shown in FIG. 1, said strap being shown in an extended configuration.

FIG. 5 is a fragmentary side elevational view of the strap shown in FIG. 4.

FIG. 6 is a fragmentary top plan view of the strap shown in FIG. 5.

### DETAILED DESCRIPTION OF A PREFERRED EMBODIMENT OF THE INVENTION

In the following description, the same numerical references refer to similar elements. The embodiment shown in the figures is preferred.

Moreover, although the present invention was primarily designed for use with a garage door, it could be used with other cable-operated doors, such as slidable truck doors for example, as apparent to a person skilled in the art. For this reason, expressions such as “garage door” and any other references and/or other expressions equivalent thereto, should not be taken as to limit the scope of the present invention and includes all other objects and all other purposes with which the present invention could be used and may be useful.

In addition, although the preferred embodiment of the leaf bumper assembly as exemplified herein comprises various components such as an L-shaped bracket, lining, rivets, bolts, etc., and although the preferred embodiment of the leaf bumper assembly as shown consists of a J-shaped configuration as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the leaf bumper assembly according to the present invention, as will be explained hereinafter, without departing from the scope of the invention.

Moreover, expressions such as “cable-operated door” and “garage door” as well as any equivalent expressions and/or compound words thereof, may be used interchangeably in the context of the present description. The same applies for any other mutually equivalent expressions, such as “track” and “rail” for example, as well as “spring” and “bumper”, as also apparent to a person skilled in the art.

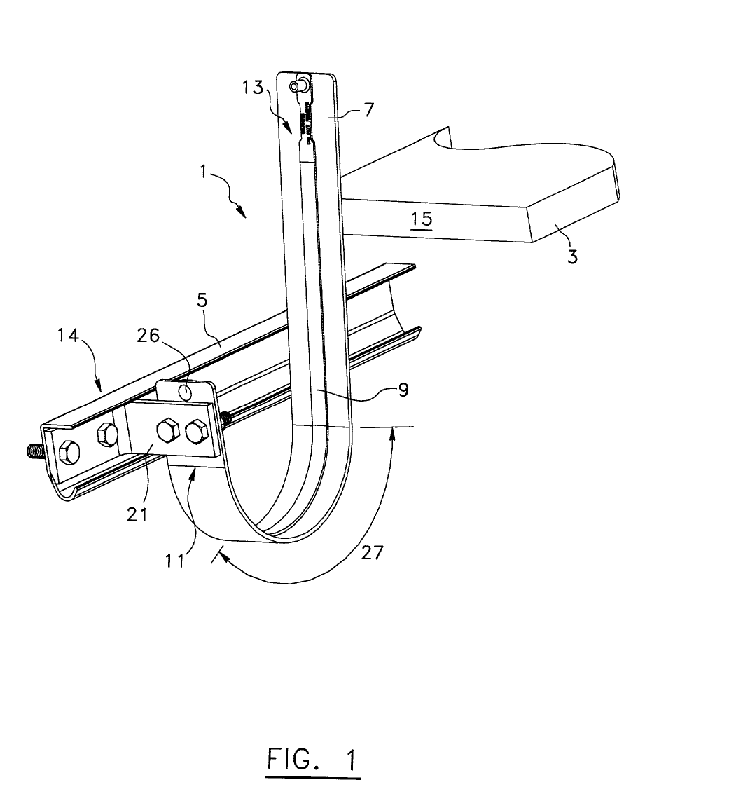

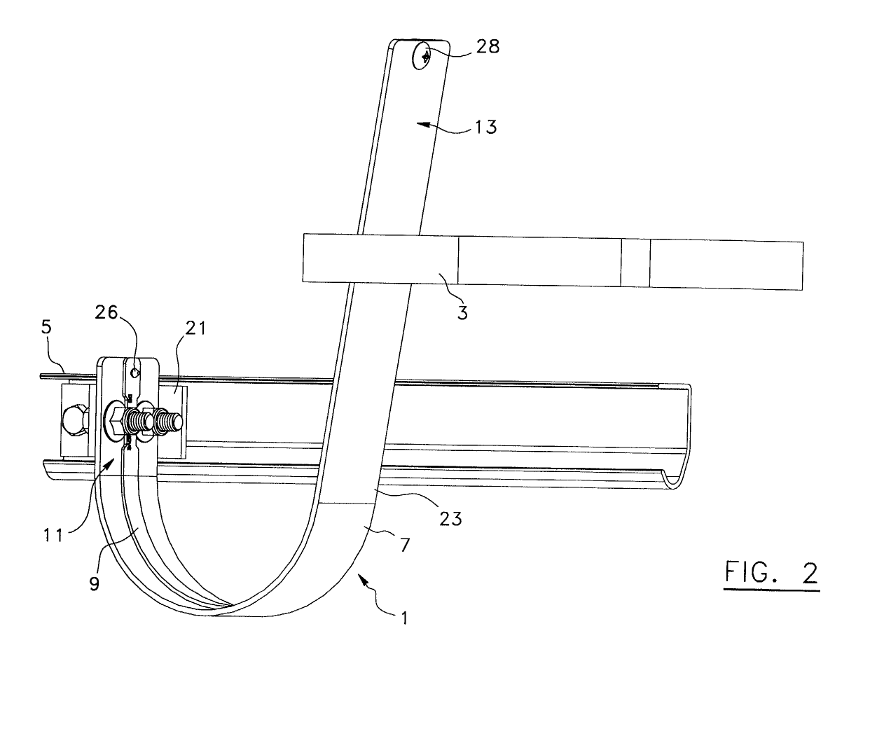

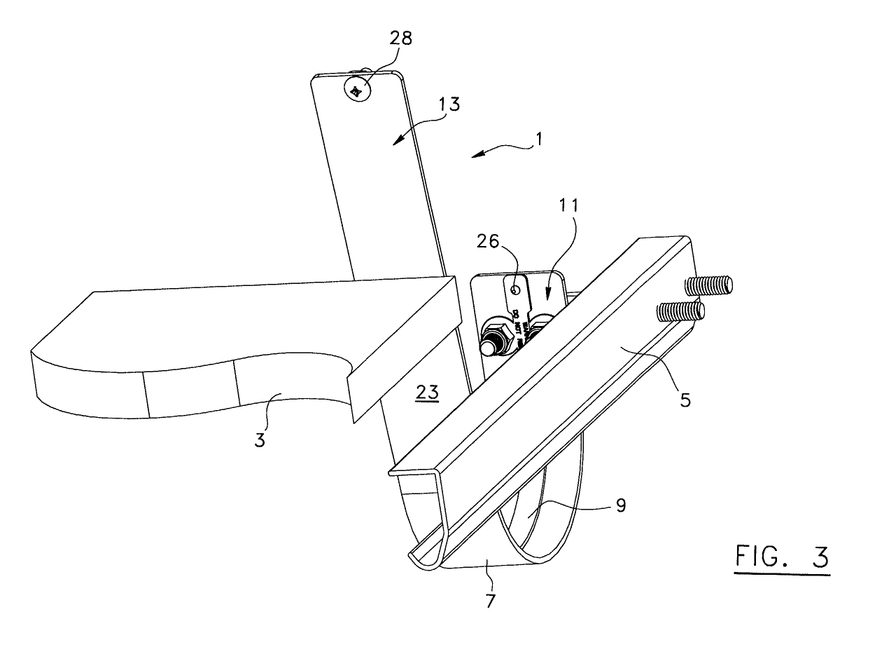

Broadly described, and referring more particularly to FIGS. 1-3, the leaf bumper assembly 1 according to the present invention is a leaf bumper assembly 1 for stopping displacement of a cable-operated door 3 guided along a side rail track 5. The leaf bumper assembly 1 comprises essentially a bracket 7 and a strap 9. The bracket 7 has a first portion 11 being rigidly connected to a fixed structure 13 and a second portion 13 being positioned to abut with an edge 15 of the cable-operated door 3 for stopping displacement thereof, as better shown in FIGS. 1 and 2. The strap 9 has a first end 17 being affixed to the first portion 11 of the bracket 7 and a second end 19 being affixed to the second portion 13 of the bracket 7.

Preferably, the fixed structure 13, onto which the first portion 11 of the bracket 7 is connected, is a portion of the side rail track 5, as better shown in FIGS. 1-3. The first portion 11 of the bracket 7 is preferably connected to the portion of the side rail track 5 by suitable connecting means, such as an L-shaped bracket 21 and fasteners for example. It is to be understood that the first portion 11 of the bracket 7, according to the present invention, may be mounted onto other suitable fixed structures, such as a side wall or a bracket of a wall/ceiling for example, as apparent to a person skilled in the art.

As better shown in FIGS. 1 and 2, the bracket 7 and the strap 9 have complementary J-shaped configurations. It is worth mentioning here that other suitable shapes may be used for the leaf bumper assembly 1 according to the present invention, so long as the first portion 11 of the bracket 7 is securely connected to a fixed structure 13 and the second portion 13 of the bracket 7 is positioned to stop the end travel of the garage door 3 by abutting with an edge 15 thereof, as apparent to a person skilled in the art. The second portion 13 of the bracket 7 may be provided with a lining 23 for receiving the edge 15 of the garage door 3. The lining 23 is preferably made of a suitable damping material, such as an elastomer for example, for protecting the second portion 13 of the bracket 7 and also partially absorbing the impact of the garage door 3 as it abuts with the second portion 13 of the bracket 7.

Preferably, the bracket 7 is manufactured by an appropriate process and made of an appropriate material so as to have suitable mechanical properties for carrying out its function as a garage door bumper, as apparent to a person skilled in the art. Among other mechanical properties, the bracket 7 is preferably resilient so as to return to its initial J-shaped configuration after abutting and stopping the garage door 3. Preferably, the bracket 7 is made of a suitable metallic material, such as steel for example, allowing the bracket 7 to be easily and inexpensively manufactured by well known processes. It is worth mentioning that other suitable materials may be used for the bracket 7, such as composite materials for example, depending on the particular applications for which the leaf bumper assembly 1 is intended for, as also apparent to a person skilled in the art.

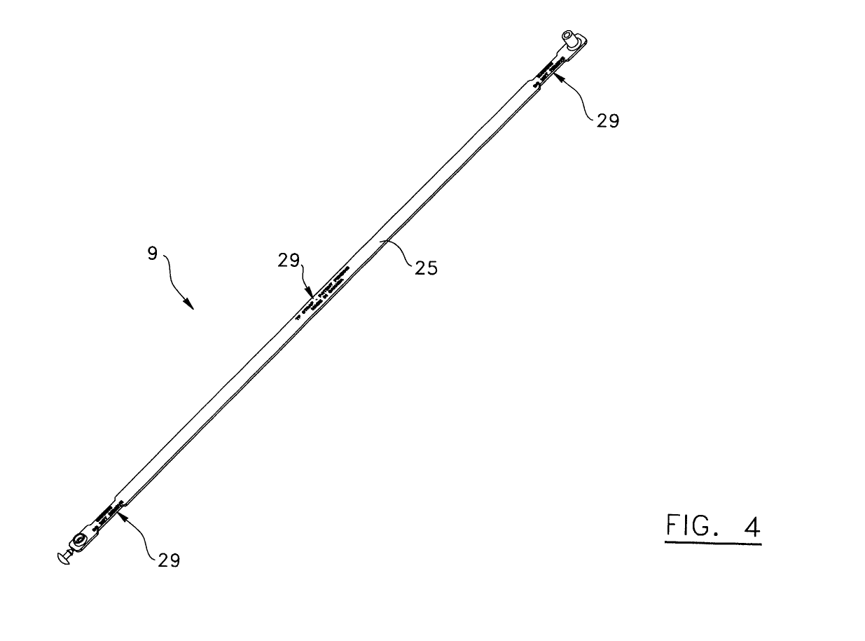

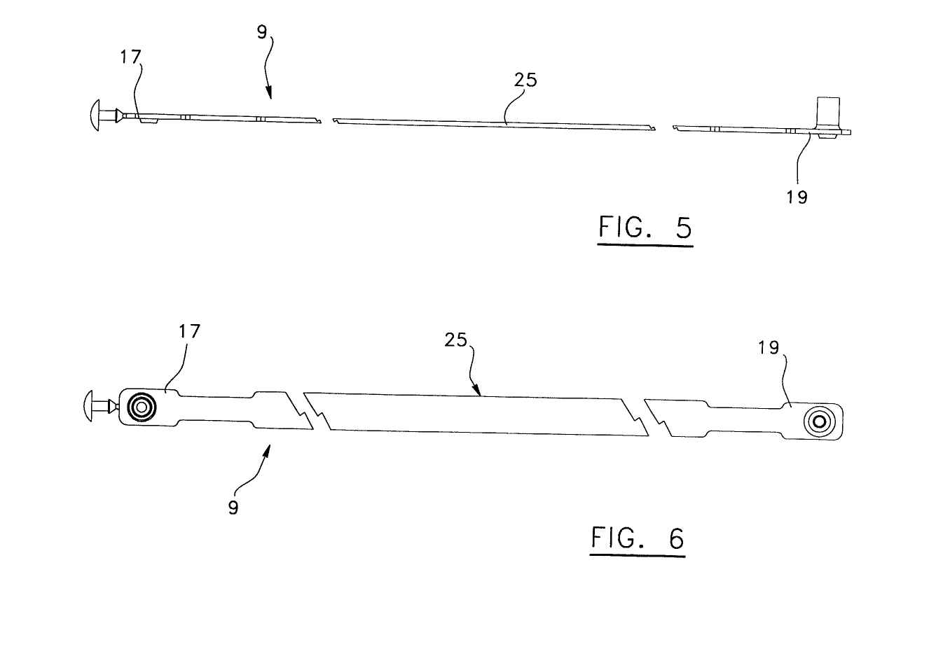

Referring now to FIGS. 4-6, there are shown different views of the strap 9 of the leaf bumper assembly 1. The strap 9 is preferably manufactured by an appropriate process and made of an appropriate material so as to have suitable mechanical properties, as apparent to a person skilled in the art, in order to hold a segment of the bracket 7, onto which the second end 19 of the strap 9 is affixed, which may break-off from the first portion 11 of the bracket 7 due to fatigue stress, and/or any other normal operating cause, so as to prevent said broken segment from falling down to the ground.

Preferably, the strap 9 has a strip-like body 25 and is flexible so as to allow it to take the shape of the bracket 7 when installed thereon. Among other advantages, this flat shape of the strap 9 helps it to remain seated in the inner section of the bracket 7, and thereby avoid interference with any other parts, as better shown in FIGS. 1 and 2. Preferably, the opposite ends 17, 19 of the strap 9 are each adapted to receive a connector thereon for securing both ends 17, 19 of the strap 9 onto the bumper bracket 7. As shown in the illustrated embodiment, the strap 9 of the present invention is preferably connected at one end 17 by a plastic rivet 26 and is connected at the other end 19 by a bolt 28 screwed into the bracket 7. The second end 19 of the strap 9 is preferably provided with a sleeve for receiving the bolt 28, as better shown in FIG. 6. It is worth mentioning that the strap 9 may be affixed onto the bracket 7 by other suitable connecting means, such as bolts, nuts, fasteners and the like, as well as with adhesive means for example, and may be affixed continuously and/or discontinuously along the bracket 7, so long as one point of the strap 9 is securely affixed to the first portion 11 of the bracket 7 and another point of the strap 9 is securely affixed to the second portion 13 of the bracket 7, because failure of the bracket 7 (i.e. breaking thereof usually occurs between both ends of the bracket 7. Normally, the fracture occurs in the bent portion 27 of the J-shaped bracket 7, as better shown in FIG. 1, but the present invention is not restricted to that particular area, as can be easily understood and as apparent to a person skilled in the art. The leaf bumper assembly 1 according to the present invention is devised so that, if fracture occurs along the bracket 7, both parts of the bumper bracket 7 will stay attached together by means of the bumper strap 9, i.e. nothing falls to the ground.

Preferably, the strap 9 is made of polymeric material (e.g. nylon), although other suitable materials may be used for the strap 9 in order to carry out the above-mentioned functions, as also apparent to a person skilled in the art. Preferably also, the strap 9 has a vivid color so as to enable a person to see whether or not a strap 9 is installed onto the bracket. According to the preferred embodiment of the invention, the strap 9 is made of a linear low-density polyethylene (LLDPE) of orange color, but other suitable colors, whether plain or fluorescent, may also be used. Yellow and green are just a few examples.

Preferably also, the strap 9 comprises at least one sign 29 selected from the group consisting of names, words, numbers, logos, trademarks and symbols conveying information. Indeed, the strap 9 may be provided with visual and/or textual description, so as to convey to a user information concerning the properties of the strap 9, the type of bracket 7 with which it may be used, details concerning the manufacturer of the strap 9, and/or other safety measures and information of interest. For example, a warning sign may be provided onto the strap 9 for advising people not to remove the strap 9 from the bracket 7.

During normal operation of a garage door 3, its upper edge 15 will hit the second portion 13 of the leaf bumper assembly 1. The leaf bumper assembly 1 will thus abut with the garage door 3, preventing it from going further along the side rail track 5. Depending on the door size (i.e. weight), the door speed, and the number of repeated impacts onto the leaf bumper assembly 1, the bracket 7 may eventually break due to fatigue or the force applied thereon. As mentioned previously, such breaking usually occurs in the curved portion 27 of the J-shaped bracket 7, but is not necessarily limited to that particular area. As explained hereinabove, the present invention proposes a strap 9 having ends respectively connected to opposite portions 11, 13 of the bracket 7, thereby preventing the falling to the ground of any broken part of the bracket 7, should breaking of the bracket 7 occur. As it can be easily understood, the strap 9 of the present invention will not keep the J-shaped configuration of the leaf bumper assembly 1 due to its flexibility but is devised by means of its mechanical properties and connecting means onto the bracket 7 to prevent any broken parts of the bracket 7 from falling down to the ground.

As may now be appreciated, the leaf bumper assembly 1 according to the present invention is an improvement over the prior art in that, as discussed hereinabove, the leaf bumper assembly 1 by virtue of its strap 9 prevents broken pieces from falling to the ground when the bracket 7 of the assembly 1 is broken, thereby preventing important damages to property and serious injuries to people. Moreover, the leaf bumper assembly 1 according to the present invention is also advantageous over the prior art in that the addition of the strap 9, as explained herein, is an inexpensive and effective way of increasing the safety of the leaf bumper bracket 7. Moreover, the present invention is also advantageous over the prior art in that, as it can be easily understood, the strap 9 is easy and inexpensive to manufacture, and easy to use onto new and already existing leaf bumper springs (i.e. bumper brackets 7).

Of course, numerous modifications could be made to the above-described embodiments without departing from the scope of the invention as defined in the appended claims.

1. A leaf bumper assembly for stopping displacement of a cable-operated door guided along a side rail track, said leaf bumper assembly comprising:
a bracket having first and second portions, the first portion of the bracket being rigidly connected to a fixed structure and the second portion of the bracket being positioned to abut with an edge of the cable-operated door for stopping displacement thereof; and
a strap having first and second ends, the first end of the strap being affixed to the first portion of the bracket and the second end of the strap being affixed to the second portion of the bracket.

2. A leaf bumper assembly according to claim 1, wherein the fixed structure is a portion of the side rail track.

3. A leaf bumper assembly according to claim 2, wherein the first portion of the bracket is connected to the portion of the side rail track by means of an L-shaped bracket.

4. A leaf bumper assembly according to claim 1, wherein the bracket and the strap have complementary J-shaped configurations.

5. A leaf bumper assembly according to claim 1, wherein the second portion of the bracket is provided with a lining for receiving the edge of the cable-operated door.

6. A leaf bumper assembly according to claim 1, wherein the bracket is resilient.

7. A leaf bumper assembly according to claim 1, wherein the bracket is made of a metallic material.

8. A leaf bumper assembly according to claim 1, wherein the strap is flexible.

9. A leaf bumper assembly according to claim 1, wherein the strap is made of a polymeric material.

10. A leaf bumper assembly according to claim 1, wherein the strap has a strip-like body.

11. A leaf bumper assembly according to claim 1, wherein the strap has a color selected from the group consisting of orange, yellow and green.

12. A leaf bumper assembly according to claim 1, wherein the strap comprises at least one sign selected from the group consisting of names, words, numbers, logos, trademarks and symbols conveying information.

13. A leaf bumper assembly according to claim 1, wherein the cable-operated door is a garage door.

14. A leaf bumper assembly for stopping displacement of a garage door guided along a side rail track, said leaf bumper assembly comprising:
a bracket having first and second portions, the first portion of the bracket being rigidly connected to a fixed structure and the second portion of the bracket being positioned to abut with an edge of the garage door for stopping displacement thereof; and
a strap having first and second ends, the first end of the strap being affixed to the first portion of the bracket and the second end of the strap being affixed to the second portion of the bracket;
wherein the first portion of the bracket is connected to a portion of the side rail track by means of an L-shaped bracket; and
wherein the bracket and the strap have complementary J-shaped configurations.

15. A leaf bumper assembly according to claim 14, wherein the second portion of the bracket is provided with a lining for receiving the edge of the garage door.

16. A leaf bumper assembly according to claim 14, wherein the bracket is made of a metallic material and the strap is made of a polymeric material.

17. A leaf bumper assembly according to claim 14, wherein the strap has a strip-like body.

18. A leaf bumper assembly according to claim 14, wherein the strap has a color selected from the group consisting of orange, yellow and green.

19. A leaf bumper assembly according to claim 14, wherein the strap comprises at least one sign selected from the group consisting of names, words, numbers, logos, trademarks and symbols conveying information.
